(19) United States
(12) Patent Application Publication
(10) Pub. No.: US 2008/0216388 A1
(43) Pub. Date: Sep. 11, 2008

(54) COLLAPSIBLE CRAB TRAP

(75) Inventor: Gary Dean Thorsen, La Conner, WA (US)

Correspondence Address: MILLER NASH LLP, 601 UNION STREET, SUITE4400, SEATTLE, WA, 98101-2352, US

(73) Assignee: MILLER NASH LLP, Seattle, WA (US)

(21) Appl. No.: 12/045,642

(22) Filed: Mar. 10, 2008

Related U.S. Application Data
(60) Provisional application No. 60/893,773, filed on Mar. 8, 2007.

(51) Int. Cl. A01K 69/10

(52) U.S. Cl. 43/105; 43/100

(57) ABSTRACT

A collapsible trap for crabs and crustaceans is disclosed having a flexible upper ring and a rigid lower ring covered with a net material forming an interior chamber. The flexible upper ring is made of flexible, yet memory retaining materials, that resist deformation in normal use in its open state, and are corrosion-resistant, wear-resistant, particularly to repeated flexing without cracking, in the presence of harsh marine environment. The collapsible trap is capable of assuming a normally open state for use, and a partially and completely collapsed states by manually twisting and coiling the flexible upper ring onto itself in one or more smaller rings until the upper ring is the same size as the rigid lower ring. In the collapsed position, the collapsible trap takes up much less space than in the open position, thereby allowing ease of transportation and storage when carried and stored in a bucket, bag, or a small compartment of a boat or a car.

### CROSS-REFERENCE TO RELATED APPLICATION

This application claims priority from U.S. Provisional Application No. 60/893,773, filed Mar. 8, 2007. The benefit of the filing date of the provisional application is hereby claimed, and the disclosure of the provisional application is hereby incorporated by reference.

### FIELD OF INVENTION

The present invention relates to a trap for catching marine life. More specifically, the present invention is directed to a flexible crab trap, which is collapsible for ease of storage and transportability and readily expandable for use in fishing for crab.

### BACKGROUND OF THE INVENTION

Fishing and gathering marine life, including crabs and other crustaceans such as lobsters, crayfish and prawns, have long been popular among individuals and commercial suppliers of seafood. In recent years, the popularity of recreational crabbing has increased immensely. Many types of crab and crustacean traps of varying shapes and sizes have been developed. These known traps have been refined with newer materials and features to meet the increased needs of sellers, suppliers, manufacturers, and purchasers of crab and crustacean traps.

One popular form of crab trap is a crab ring. A crab ring usually consists of two rings—an upper ring and a lower ring connected by a circular mesh or net material, and a bottom portion formed of the net material stretched over the lower ring. The structure of the crab ring forms essentially a basket-shaped and receptacle with an open top. This basket-shaped receptacle basically uses bait attached to the bottom portion to attract the desired crustacean. A rope or line is attached to locations on the outer circumference of the upper ring, and the crab trap is lowered into fishable water. As the crab trap reaches the bottom of a particular marine environment, the upper ring settles onto the lower ring to provide an essentially flat surface onto which feeding crabs are allowed to approach the bait within the trap. When the crab trap is lifted by the rope from above, the upper ring is raised with respect to the lower ring, and any crab or other crustacean still engaged with the bait is caught within the basket-shaped receptacle as the crab trap is pulled to the surface.

Generally, the larger the rings of a ring type crab trap, the greater the capacity for catching a greater number of crabs at a time. A problem exists in that the larger the rings, the more unwieldy the trap becomes as lifted out of water with the weight of a plurality of crustaceans and for purposes of transporting and storing the trap. It is therefore desirable to have an easily collapsible crab trap that benefits from the functionality and simplicity of design provided by the customary ring style of a crab trap, while allowing for ease of transportability and storage when the trap is not in use.

Crab traps with a ring type are known in the industry that have flexible rings for purposes of folding the rings in figure-eight patterns to create a smaller profile for storage. Materials used and taught by these disclosures include flexible steel band materials, stainless steel cable, spring steel, fiberglass and carbon fiber. A problem exists with flexible rings known for use in crab trap construction in that larger rings have a tendency to flex flimsily and excessively, particularly under a heavy load when a full trap is being raised to the surface from the water. The larger flexible ring types have a tendency to flex inwardly, possibly damaging or ejecting crabs caught and contained within the trap. The larger flexible ring types also have the problem of flexing outwardly and losing a number of entrapped crabs and allowing the entrapped crabs to escape. Flexing rings currently in use may also allow the adjoining netting to become more readily entangled which prevents the trap from assuming its desired shape on the bottom of the water. It is therefore desirable to have a flexible ring for use on a crab trap that is sufficiently flexible to allow for easily folding and collapsing the trap to a smaller size, while providing sufficient rigidity to withstand deformation during its intended use as part of a collapsible trap.

Another problem with currently known flexible rings is that the materials for construction are not sufficiently robust to withstand the harsh marine environment, including repeated exposure to water, sun, extreme temperatures and corrosive salt. Steel is especially subject to oxidation and corrosion in the presence of salt water. It is therefore desirable to have a flexible ring for use in a crab trap that is formed of a material that will withstand the harsh conditions of use in a marine environment, while retaining desirable flexible properties over a sustained life of the product. It is further desirable that materials used resist cracking or loss of flexible properties because of constant exposure to the combination of salt water and the sun over time.

It has been the experience of experts in the field of sporting goods and fishing tackle providers, as well as that of fishermen and crabbers, that workable and commercially viable flexible or coilable crab rings based on previously known materials and methods of construction are absent from the marketplace. This is particularly evident along the Oregon coastal territory stretching from the town of Tillamook in the north to the town of Bandon in the south, widely regarded as a prime area for recreational crabbing with a season that is open 24/7 year round. Even the Danielson Company, a manufacturer of the FTC collapsible crab trap, the best selling crab trap in the United States, and many of the Pacific Northwest's most respected sporting goods dealers, collectively responsible for the highest sales volumes for crabbing supplies, are unfamiliar with workable crab traps based on previously known materials and construction.

In particular, no product exists on the market that provides a collapsible trap for crab and crustacean having a flexible upper ring in combination with a rigid lower ring that can withstand the inevitably harsh environmental conditions in crabbing and similar activities.

### BRIEF DESCRIPTION OF THE DRAWINGS

The aspects and many of the attendant advantages of this invention will become more readily appreciated as the same become better understood by reference to the following detailed description, when taken in conjunction with the accompanying drawings, wherein:

FIG. 1 is a perspective view of an exemplary collapsible trap shown in an open state.

FIG. 2 is a perspective view of an exemplary collapsible trap shown in an open state with an attached floating element.

FIGS. 3A, 3B, and 3C are top views of an exemplary collapsible trap on a flat surface illustrating the different stages of collapsing the trap from an open state to a partially collapsed state to a completely collapsed state.

FIGS. 4A and 4B are side views of an exemplary collapsible trap shown in a partially collapsed state to a completely collapsed state.

FIG. 5 is a perspective view of an exemplary collapsible trap shown in an open state and held by a user.

FIG. 6 is a perspective view of an exemplary collapsible trap shown in an open state containing a plurality of crustaceans as held by a user.

### DETAILED DESCRIPTION OF THE INVENTION

The above-described problems are solved and a technical advance achieved by the present invention for a collapsible trap for crabs and other crustaceans. A crab ring-type trap with novel features enables improved transportability and storage while the trap is in its collapsed state. Improved rigidity and wear-resistance features also greatly contribute to improved performance, extended product life and increased value to a purchaser of the trap product.

A collapsible trap 10 for crabs and crustaceans is disclosed having at least two ring members 20, 30. The trap has an upper ring member 20 with flexible properties and a lower ring member 30 that has rigid properties. A mesh 40, comprised of flexible water-permeable material such as a commonly known netting material, is fastened all around the circumferential surface of the flexible upper ring member 20 and also fastened all around the circumferential surface of the rigid lower ring member 30. The mesh 40 as fastened from the upper ring member 20 to the lower ring member 30 define the side portion of the mesh 41. The mesh 40 also covers the bottom opening of the rigid lower ring member 30 to form a closed bottom portion of the mesh 42. An interior chamber is defined by the side portion of the mesh 40 and the bottom portion of the mesh 42 in which at least one crab or crustacean can be caught and contained.

The upper ring member 20 is made of a flexible, yet memory retaining material, or a combination of materials. The flexible, and optionally memory retaining materials of the upper ring member 20 are corrosion-resistant and wear-resistant despite repeated exposure to salt water and ultra-violet (UV) radiation from the sun. The upper ring member 20 of the present invention will also withstand the cracking due to repeated flexing and collapsing of the upper ring member 20 after constant exposure to sea water and UV radiation from the sun. In one preferred embodiment of the present invention, the flexible upper ring member 20 is made of a coiled spring that is jacketed with a flexible epoxy coating. The memory retaining properties of the flexible upper ring member 20 allow the collapsible trap 10 to assume a normally open state which would be required when fishing for crabs and crustaceans.

List of Materials that can be Used for Manufacturing the Coiled Spring:

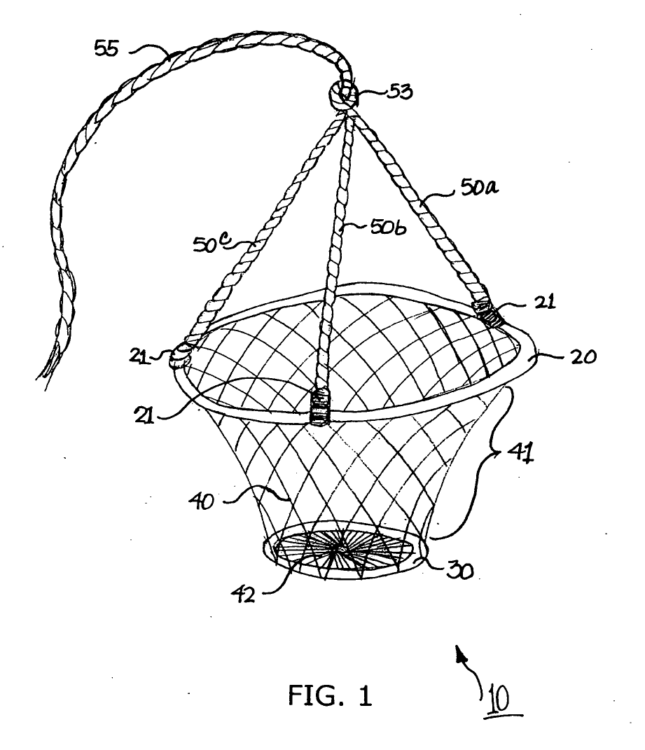

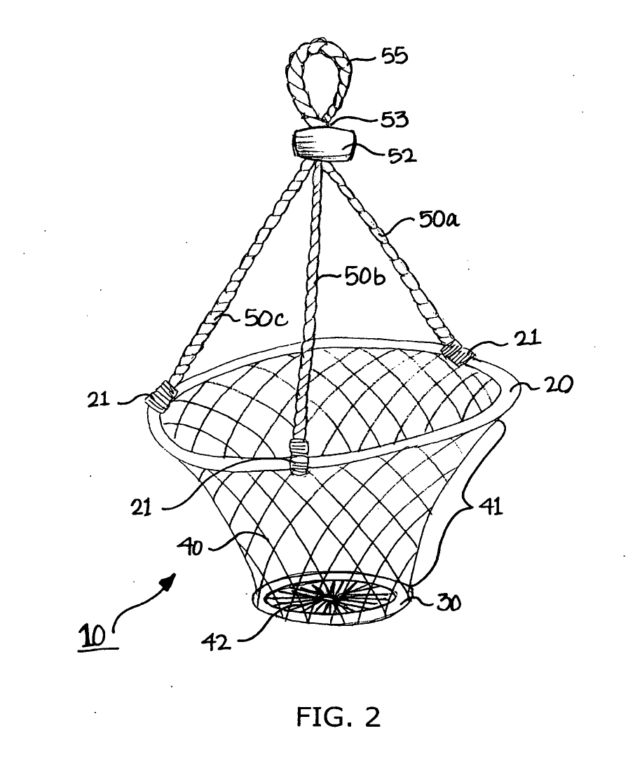

In an exemplary embodiment of FIGS. 1-2, the coiled spring of the upper ring member 20 is typically made and manufactured from a wire on a machine, preferably a spring coiling machine. The coils can be made, or essentially wrapped with spacing between the coils or without any spacing between the coils. If the coils are wrapped with spacing between the coils, the coils will have easily bend causing torsion or extension of the spring. However, if the spring coils are made without any spacing between adjacent coils, the spring coils cannot be easily compressed due to tightness of coils. It is desirable to make the spring coils without any spacing between the coils to allow the adjacent coils to support one another due to closeness, thereby assisting in retention of a desired shape of the flexible upper ring member 20. In an exemplary preferred embodiment, the coiled spring without any spacing is wrapped with strips of Ethylene Propylene Diene Monomer (“EPDM”, a commonly known elastometric rubber product, to protect the spring from corrosion and to prevent pinching of the user by the flexing of the spring. By wrapping the coiled spring helically with strips of EPDM, the memory characteristics are reinforced, thereby aiding in the outward thrusting of the upper ring member 20 and enhancing the circular shape of the upper ring member 20.

The spring coils can be made from a wide variety of known metals. The spring coil materials can be optionally or additionally tempered to create a stronger and longer lasting coiled spring of the flexible upper ring member 20. The spring coils are made of wires from a variety of different materials with varying tensile strengths and diameters. Some of the most common types of wires readily available include music wire, oil-tempered, stainless, copper, bronze, and titanium. These metal materials are meant to be exemplary and not to limit the scope of the invention. Titanium tends to be the strongest material, however. Titanium is not the first choice of wire materials to be used for making the upper ring member 20 due to high cost of the material. Other substitute wire materials are preferred, at least for now, over titanium due to cost. Stainless steel is another commonly available wire material and used in more expensive solid frame crab trap designs. Even though stainless steel is a wire that is highly resistant to corrosion, it is considerably weaker than other known wire materials when constructed as a coiled spring assembly for the flexible upper ring member 20. These characteristics of cost and weakness do not exclude the use of wires made of titanium and stainless steel. However, titanium and stainless steel are less desirable as construction materials for the coiled springs for the flexible upper ring members 20 of the present invention. Also, other similarly strong materials with properties exhibited by metal materials can be used, and the coiled springs are not limited to only using the materials as herein mentioned.

In one exemplary embodiment, a collapsible trap 10 is a 28-inch model with the upper ring member 20 constructed using music wires with a smaller diameter in the range of 0.072 inches to 0.105 inches which can be wrapped into coils to make a spring. The coils made with music wires feature a torsion spring that is very tightly wound because the coiled spring is made without any spacing between the coils. In another exemplary embodiment, a collapsible trap 10 is an 18-inch model with the upper ring member 20 constructed using music wires with a smaller diameter of 0.105 inches. The music wires are constructed by wrapping the wires into coils forming a hollow coiled spring with the outer diameter of 0.3750 inches and an inner diameter of the hollow portion being 0.1650 inches. The number of coils formed in this exemplary embodiment is approximately 1900 coils constructed from the music wire with a length of 1615 inches. This particular embodiment can withstand a load of 68.4 lbs to a maximum load of 132 lbs and has been tested to deflect over 1,000,000 times. This example has a spring rate of 4.67 lbs per inch.

Although it is cost effective and quite suitable to use wires with smaller diameters, such as music wires, for constructing spring coils, music wires as with the other less expensive wires are very susceptible to the corrosive effects of water, especially salt water. Any rust preventative treatment of the spring coils has obvious benefits such as an under coating.

In another exemplary embodiment, a coiled spring can be replaced with a flat piece of spring steel which is welded at the two ends of the piece. Thinner wires with smaller diameters or treated wires, such as tempered wires, are more cost effective while the disadvantage is that more wires would be required due to their thinner diameter to result in a tightly wound configuration to effectively meet the demands of every day use for crabbing and similar activities. These restrictions on cost are meant to be exemplary and not to limit the scope of the invention by using wires with a smaller diameter. Other suitable materials and alternatives for constructing springed coils may be considered that is more cost-effective while achieving the desired characteristics.

In another exemplary preferred embodiment, the upper ring member 20 may also be constructed by using thicker wires with a larger diameter. For upper ring members 20 with coils constructed using larger diameter wires, it is preferable to construct the torsion or compression spring with spacing between the coils in order to achieve the desired characteristics. By constructing the compressible spring coils using thicker wires with larger diameters, it is advantageous because less wire materials are required and use of thicker wires have an added strength benefit. Using less wire materials also translates into a cost advantage as well. This alternative process of using thicker wires can optionally include either a sealing treatment for flexibility and corrosion resistance or a dipping process, or an extrusion process, by which the spring is embedded in a flexible material such as EPDM, polymer or other flexible material that can withstand the elements. These additional treatments of coating or coverings allow for memory retention and enhanced performance of the upper ring member 20 as incorporate in the collapsible trap 10. In the exemplary embodiment, the coiled spring of the upper ring member 20 is covered with a polyethylene tubular coating, and the electrical- or chemical-resistant tape can patch over any open areas of the tubular coating edges which are further sealed by adhering any heat shrinkable polymer material, such as a polyvinyl chloride (PVC), to completely seal the coiled spring from water. Optionally, the polyethylene tubing can be heat treated to seal without the use of any electrical- or chemical-resistant tape or heat treating a shrinkable polymer material over the polyethylene tubing.

It will be readily understood by those skilled in the art that any tubular, dipped, extruded flexible casing, protective coating, or otherwise attached covering could also provide these benefits. This coating can be comprised of flexible epoxy, EPDM, hose, extruded polymer, flexible woven wire, rubber, polyethylene, or any other flexible compound with the desired characteristics that would encase or adhere to the coiled springs or other core materials used. The elements of the upper ring member 20 can optionally be protected with an anodized or galvanized coating. These materials and processes are meant to be exemplary and not to limit the scope of the invention.

In an additional preferred embodiment, other substitutable materials for making the flexible upper ring member 20 include using fiberglass, other glass-embedded compounds, graphite or carbon fiber, polymer, or other similar composite materials for forming an inner core element of the ring member 20. These materials have the desired memory retaining and spring-like qualities for use in a flexible ring as in the upper ring member 20, but the fiber materials, when constructed, require at least the same protection against the elements as the metallic materials. The fiberglass and other similar materials also require a coating for safety reasons because a broken piece can cause serious injury to users.

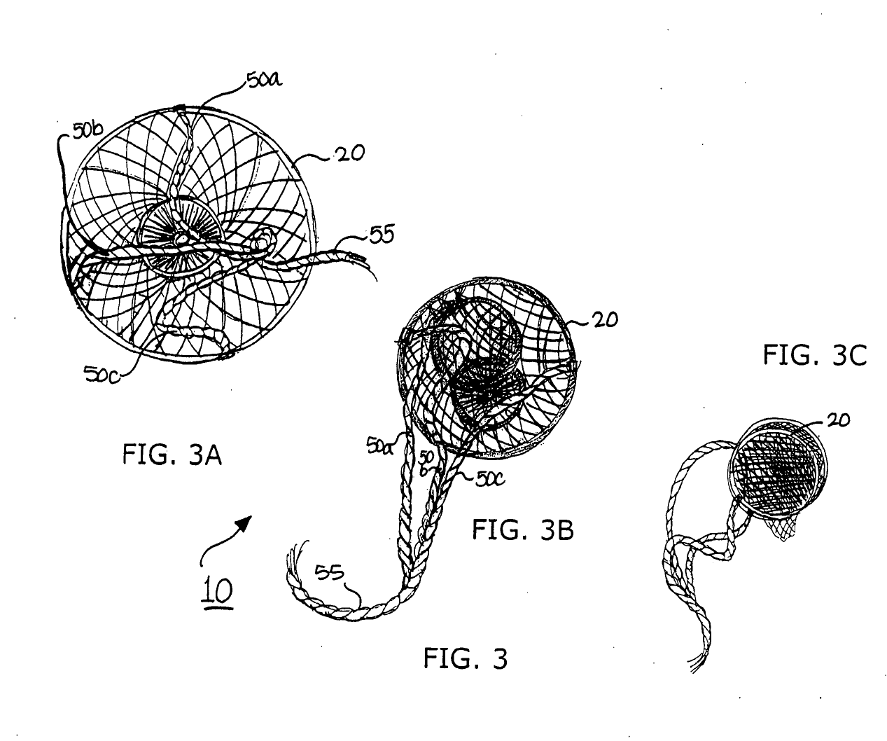

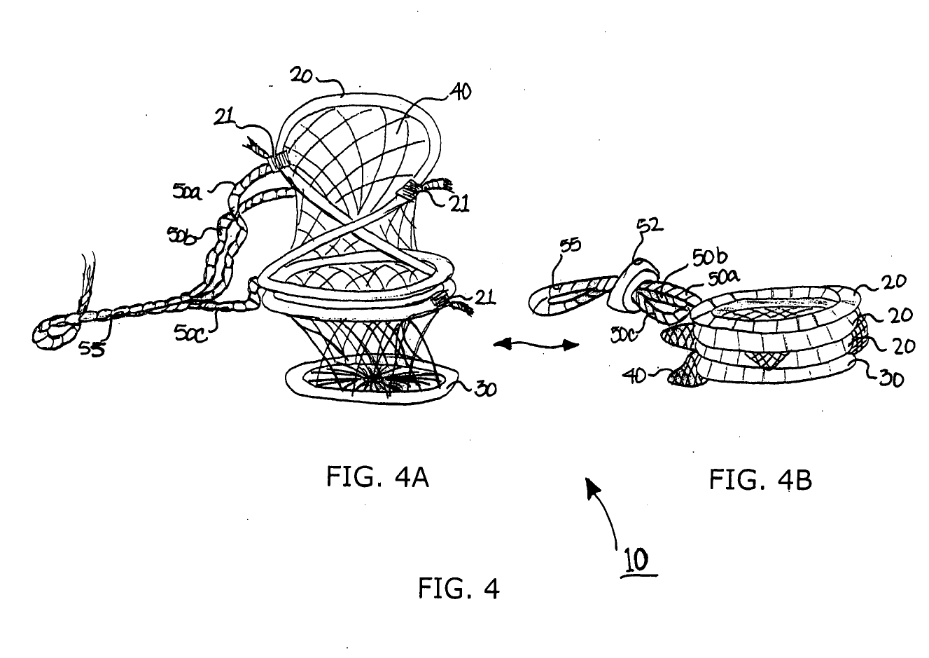

Optionally, a rod can be inserted inside the spring coils for added support and strength or a rod can be used alone with the coiled spring. A fiberglass rod works very well when inserted inside the spring coils for additional support. The optional rod is effective in other types of springs as well as the mentioned coatings or casings. With spring coils exhibiting proper strength, a rod is not necessary because a rod that is too stiff and strong can prevent the coiled springs to stay in its collapsed state. Any rod made of fiberglass or other materials are not preferred to be inserted into the coiled springs or used alone if the rod creates a degree of rigidity that prevents the flexible upper ring member 20 from being coiled onto itself and collapsed to at least the size of the rigid lower ring member 30 as illustrated in FIGS. 3 and 4.

In FIGS. 1-2, there are several possible ways that the ring elements are attached at the ends to form the upper ring member 20. In one embodiment of the present invention, the upper ring member 20 as a full length stick is easily insertable through the interweaving of the mesh 40 to form the side portion of the mesh 41 without a need to attach or fasten the mesh 40 to the circumferential area of the upper ring member 20. The ends of the open upper ring member 20 are then attached by different means. One exemplary embodiment allows inserting a short metal rod in the inner core to allow for flexibility of the joint and welding the ends of the coiled spring together at and to the rod. In another embodiment of the present invention, the ends are attached in much the same manner, but the ends are welded together with epoxy-based glue. In another embodiment, the upper ring members 20 can also be formed by attaching the ends by inserting the ends of the springs into a short sleeve and then gluing them with epoxy.

In yet another exemplary embodiment of the invention, a sleeve with inner threading is feasible in which the coiled spring acts like a screw around which the sleeve can be threaded on one end and then back threaded onto the other end to achieve a perfect bond without any use of welding or gluing. Therefore, having a threadable sleeve into which springs can be threaded is a preferred design since no welding or gluing process is required for attaching the ends of the coiled springs together. In yet another exemplary embodiment, the coiled spring can be flared at one end allowing the smaller end to be threaded into the flared end for joining the two ends together to form the upper ring member 20. Sleeves can alternatively be comprised of a crimped, or pressed-on design without using the threadable attachment. Any means of attachment can be adopted in attaching the inner core elements of the upper ring member 20 using different materials as mentioned. The coating material can be chemically welded and any additional coating can be further applied to fill in gaps and to form a uniform upper ring member 20. Additionally, the upper ring member 20 is completely sealed to prevent any rusting of and leaking rust from the coiled springs.

Any coating process can be applied by dipping, spraying, inserting, extruding, electro-plating, powder coating, or any other process that would allow the flexible inner core material, whether a spring, rod or polymer, to achieve and to maintain the desired, proper characteristics. The desired characteristics include flexibility for collapsing, sufficient rigidity in an open configuration, and protection from adverse elements. It will be readily understood by those skilled in the art that any flexible rod, spring or tube-like material would also suffice as a core and could be inserted, dipped, extruded, powder coated, sprayed, sealed or coated using any other similar process.

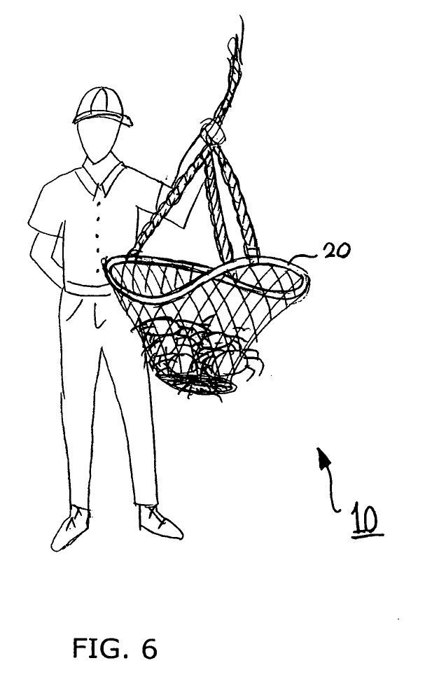

In another embodiment of the present invention, the flexible upper ring member 20 is made of coiled steel spring that is joined end-to-end to form the upper ring member 20, and the spring is wrapped with strips of EPMD rubber sheeting and sealed at the edges using any of the previously mentioned coating processes. The rubber sheet used for this particular exemplary embodiment is approximately 0.060 inches thick and provides a protective coating and a smooth surface as well as adding to the desired rigidity of the upper member ring 20 required for deployment of the trap 10 with added weight which will be best illustrated and described in FIG. 6.

The following paragraphs provide exemplary details of one exemplary collapsible trap 10 by which the present invention may be implemented. As illustrated in FIGS. 1-2, the collapsible trap 10 has at least three flexible yoke lines 50a , 50b , 50c which are attached to the flexible upper ring member 20, approximately evenly spaced about the circumference of the upper ring member 20. The flexible yoke lines 50a , 50b , 50c are attached to the upper ring member 20 at the attachment point 21 with a tied knot or any commonly known method for fastening or securing a line to the surface of the upper ring member 20. The at least three yoke lines 50a , 50b , 50c are joined together at a common union or joining point 53 at the top end, at which the yoke lines 50a , 50b , 50c are connectable to a single pull line 55. The single and flexible pull line 55 is releasably connected to the union of three yoke lines 50a , 50b , 50c at the jointing point by a knot or a releasable connector element. As illustrated in FIG. 2, the collapsible trap 10 can optionally have a floating element 52 that can releasably attach at the joining point 53.

In an exemplary embodiment, a floating element 52 or a block made of a floatable materials is releasably attached so that the yoke lines 50a , 50b , 50c can float above when the collapsible trap 10 is deployed. By using a floating element 52, a block made of materials such as wood, cork or polyurethane foam, releasably affixed at the joining point 53 of the three yoke lines 50a , 50b , 50c to the pull line 55, the floating element 52 provides a means for which entanglement of the yoke lines 50a , 50b , 50c is prevented, particularly when the trap 10 is submerged under water. The floating element 52 keeps the yoke lines 50a , 50b , 50c upwardly suspended to avoid possible entanglement with other parts of the trap 10 and any crabs or crustaceans being lured into the trap. Any floating elements 52 may be attached to any of the yoke lines 50a , 50b , 50c or the single pull line 55 at any point to add buoyancy and to accommodate different environments. Other exemplary embodiments include the use of a pull line 55 or yoke lines 50a , 50b , 50c which are floatable, or by using a combination of both. Floatation of the pull line 55 or yoke lines 50a , 50b , 50c can also be achieved without attaching a floating element 52 to the lines, but by using floatable lines 55, 50a , 50b , 50c such as poly-lines or incorporating floatation elements into the yoke lines 50a , 50b , 50c or the pull line 55. These floatable adaptations are exemplary and not to limit the scope of the invention.

As illustrated in FIGS. 1-2, the lower ring member 30 is constructed of more rigid and naturally heavier materials than the flexible materials preferred for constructing the upper ring member 20. Any type of metal or other similar materials can be used to construct the rigid lower ring member 30 that are not flexible. The rigid lower ring member 30 allows the trap 10 to land at the bottom of the water in a stable and predictable fashion every time. By having the mesh 40 of the trap 10 land predictably and downwardly as deployed to the bottom of the water, a user can easily catch more crabs and other crustaceans since deployment of the mesh 30 does not fold or entangle at the bottom of the water. In a preferred embodiment, the collapsible trap 10 comprises at least one flexible upper ring member 20 and at least one rigid lower ring member 30. The lower ring member 20 is smaller than the upper ring member 30. The size of the lower ring member 30 has an opening which is approximately one-third the size of the flexible upper ring member 20. The size ratio of 1:3, rigid lower ring member size to flexible upper ring member size, can be decreased or increased depending on the marine conditions and application, including recreational and commercial activities. The size ratio of the ring members 20, 30 are meant to be exemplary and not to limit the scope of the invention.

In an exemplary embodiment, the lower ring member 30 contains zinc for zinc galvanization. Zinc is preferably added to any elements of the present invention including the upper ring member 20. Zinc provides a desirable property in that it is an attractant to crabs and other crustaceans, and thereby improves the ability of the trap 10 to catch crabs and other crustaceans.

In yet another preferred embodiment, the flexible upper ring member 20 has a greater degree of buoyancy than the rigid lower ring member 30, although both the flexible upper ring member 20 and the rigid lower ring member 30 will not float in water. By having the flexible upper ring member 20 be more buoyant with hollow coiled springs than the lower ring member 30, the lower ring member 30 is likely to assume a lower position than the flexible upper ring member 20 when being submerged in water. This minimizes possible entanglement of the mesh 40 when the collapsible trap 10 is submerged in water and as the trap 10 is being lowered to the bottom of the water. Avoiding the entanglement and misplacement of the mesh 40, more crabs and crustaceans are likely to be caught as the trap 10 is lifted upwardly. In one example of the present invention, a weight or sinker is optionally affixed to a lower portion of the collapsible trap 10 to help avoid entanglement of the mesh 40, and to further improve stability of a deployed trap 40 in moving water. Optionally, weights or sinkers attached to the trap 10 can be comprised of zinc or include zinc for attracting crabs and other crustaceans.

A bait or other crab attractant is typically secured to the center of the bottom portion 42 of the collapsible trap 10, on the mesh 42 within the lower ring member 30. The collapsible trap 10 is then lowered into the water, supported by the pull line 55, until the collapsible trap 10 reaches the bottom of the water. The lower ring member 30 naturally reaches the bottom before the upper ring member 20. The upper ring member 20 then settles onto the bottom in a more or less concentric orientation with the lower ring member in a flattened orientation as more readily illustrated in FIG. 3A. Crabs or crustaceans will be ideally attracted to the bait or bait attractant and will readily cross over the flattened upper ring member 20 to approach the center of the trap 10 at which the bait is attached. After a period of time, the pull line 55 is raised, pulling on the yoke lines 50a , 50b , 50c , thereby lifting the upper ring member 20 upwards. The upper ring member 20 naturally lifts from the bottom of the water before the lower ring member 30, and forms a basket-like receptacle as shown in FIGS. 1-2 and FIGS. 5-6 preventing caught crabs and crustaceans from escaping sideways. As the basket-like receptacle or traps 10 are lifted out of and removed from the water, the collapsible trap 10 is laid on a flat surface to flatten the ring members 20, 30 with respect to each other in order to facilitate removal of any catch critters including crabs and other crustaceans.

Bait (not shown in FIGS.) is supported in the present invention by means of a cord, ring, clip, strap, or a commonly known bait pin. The bait support means is optionally advantageous to serve a dual purpose by further providing a means for securing the coiled upper ring member 20 to the lower ring member 30 when the trap is collapsed. Optionally, a cord, ring, clip, strap or other possible retainer can be provided to secure the coiled upper ring member 20 to the lower ring member 30 independently of a bait support means.

As illustrated in the exemplary embodiment of FIG. 3, a top view of the collapsible trap 10 shown FIG. 3A in the open state when the upper ring member 20 is not flexed or collapsed. FIG. 3B illustrates a partially collapsed upper ring member 20 whereby the flexible upper ring member 20 is manually twisted so that the upper ring member 20 is folded onto itself in a figure-8 pattern. FIG. 3C illustrates a completely collapsed upper ring member 20 whereby the flexible upper ring member 20 is manually twisted so that more figure-8 patterns are formed until the flexible upper ring member 20 is the same size as the rigid lower ring member 30. In the completely collapsed position as shown in FIG. 3C, the collapsible trap 10 takes up much less space than if it is in the fully open position. After using the collapsible trap 10, a user can easily and manually twist the flexible upper ring member 20 onto itself one or more times until the flexible ring is collapsed to the size of the rigid lower ring member 30 as illustrated in FIG. 3C.

As illustrated in the exemplary embodiment of FIG. 4, a side view of the collapsible trap 10 is shown in a partially collapsed state with the flexible upper ring member 20 forming one figure-8 pattern. In FIG. 4B, a side view of the collapsible trap 10 is illustrated in a completely collapsed state with the flexible upper ring member 20 forming three layers on top of the rigid lower ring member 30. This flexible and collapsible feature of the trap 10 allows ease of transportability and storage since it can be easily carried and stored in a bucket, bag, or a small compartment in a boat or a car. Before using the collapsible trap 10, the trap 10 is easily extended to an open state by holding one portion of the flexible upper ring member 20 and allowing the spring tension of the flexible upper ring member 20 to open outwardly in assuming the normally open state.

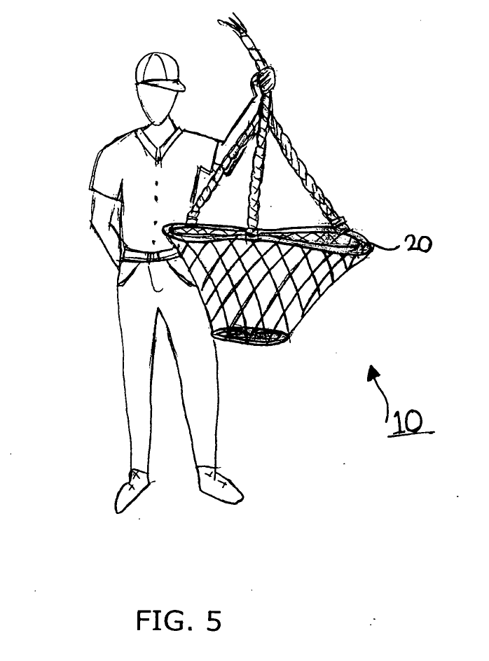

In one embodiment of the present invention, the flexible upper ring member 20 is made of a coiled steel spring with sufficient spring tension to support the flexible upper ring member 20 in an open state while minimally deforming as the collapsible trap 10 is deployed and recovered with added weight comprised of a plurality of crabs or other crustaceans as illustrated between FIG. 5 and FIG. 6. In FIG. 5, a user is lifting the collapsible trap 10 without any weight in the interior chamber of the trap 10. In FIG. 6, a user is lifting the collapsible trap 10 with added weight from the plurality of crabs and crustaceans. The flexible upper ring member 20 is required to be constructed to withstand deformation to return to its open state after repeated use. When the weight of captured crustaceans pull downwards while the yoke lines 50a , 50b , 50c are pulled upwards, the upper ring member 20 inwardly flexes with a heavy weight of entrapped crabs which prevents any catch from escaping. The slight deformation of the flexible ring member 20 is readily illustrated in the exemplary embodiment of FIGS. 5 and 6. The heavier the weight and fuller the interior chamber with entrapped crabs and other crustaceans, the more inwardly the flexible upper ring member 20 flexes while being pulled to the surface at pull line 55 keeping any catch entangled and contained.

### INDUSTRIAL APPLICABILITY

The present invention has applicability to the field of traps for catching marine life. In compliance with statute, the invention has been described in language more or less specific as to a crab trap apparatus. It is to be understood, however, that the invention is not limited to the specific means or features shown or described, since the means and features shown or described comprise preferred ways of putting the invention into effect.

Additionally, while this invention is described in terms of being used for catching crabs and other marine crustaceans, it will be readily apparent to those skilled in the art that the invention can be adapted to other uses for other traps, nets, cages and enclosure devices as well, and therefore the invention should not be construed as being limited to crab traps. The invention is, therefore, claimed in any of its forms or modifications within the legitimate and valid scope of the appended claims and are not intended to exclude equivalents of the features shown and described or portions of them.

What is claimed is:

1. A collapsible trap for catching at least one marine crustacean, the collapsible trap comprising:
(a) at least one upper ring member constructed of flexible materials and having an outward spring tension for retaining the ring member in an open configuration;
(b) at least one lower rigid ring member;
(c) a flexible water permeable mesh fastened from a first circumferential surface of the at least one upper ring member to a second circumferential surface on the at least one lower rigid ring member; and
(d) a bottom surface attached to the at least one lower rigid ring member;
whereby, an interior chamber is defined by the flexible water permeable mesh, the at least one upper flexible ring member, the at least one lower rigid ring member, and the bottom surface; and the at least one upper flexible ring member is manually collapsible to a size smaller than its circumference in a collapsed configuration.

2. The collapsible trap of claim 1, wherein the at least one upper ring member is constructed of flexible materials having a higher degree of buoyancy relative to the lower rigid ring member.

3. The collapsible trap of claim 1, wherein the flexible materials of the at least one upper ring member comprise a coiled spring.

4. The collapsible trap of claim 3, wherein the coiled spring of the at least one upper ring member further comprises a protective coating.

5. The collapsible trap of claim 3, wherein the the coiled spring of the the protective coating further comprises a sealing means by which the coiled spring is protected against rusting.

6. The collapsible trap of claim 1, wherein the at least one lower ring member has a diameter that is smaller than that of the at least one upper ring member.

7. The collapsible trap of claim 1, wherein at least three flexible lines are securely attached to the at least one upper ring member being approximately evenly spaced about the first circumferential surface and joined together with a single line at an opposite end.

8. The collapsible trap of claim 7, whereby the single line is pulled flexing the upper ring member inwardly preventing escape of any catch while lifting the trap with the at least one or more crab and other crustacean trapped within the interior chamber.

9. The collapsible trap of claim 1, wherein a bait is secured to middle of the bottom surface of the collapsible trap by at least one bait support for attracting the at least one crustacean.

10. A collapsible crab trap for catching a plurality of crabs or other marine crustaceans, the collapsible crab trap comprising:
(a) at least one upper ring member constructed of flexible materials and having an outward spring tension for retaining the ring member in an open configuration;
(b) at least one lower rigid ring member, the at least one lower rigid ring member having a diameter that is smaller than that of the at least one upper ring member;
(c) a flexible water permeable mesh fastened from a first circumferential surface of the at least one upper flexible ring member to a second circumferential surface of the at least one lower rigid ring member;
(d) a bottom surface attached to the at least one lower rigid ring member;
(e) a protective coating of the upper ring member and the lower ring member; and
whereby, an interior chamber is defined by the flexible water permeable mesh, the at least one upper flexible ring member, the at least one lower rigid ring member, and the bottom surface; and the at least one upper flexible ring member is manually collapsible to a size smaller than its circumference in a collapsed configuration.

11. The collapsible crab trap of claim 10, wherein the at least one upper ring member is constructed of flexible materials having a higher degree of buoyancy relative to the lower rigid ring member.

12. The collapsible crab trap of claim 10, wherein the at least one upper ring member is further constructed of a coiled spring.

13. The collapsible crab trap of claim 11, wherein the at least one upper ring member is further constructed of a flexible rod.

14. The collapsible crab trap of claim 10, wherein the protective coating further comprises a sealing means to prevent rusting.

15. The collapsible crab trap of claim 10, wherein the the protective coating is a tube.

16. The collapsible crab trap of claim 10, wherein at least three flexible lines are securely attached to the at least one upper ring member being approximately evenly spaced about the first circumferential surface and joined together with a single line at an opposite end.

17. The collapsible crab trap of claim 16, wherein a floatable element is attached at any point on the single line to prevent entangling of the at least three flexible lines when the collapsible crab trap is submerged in water.

18. The collapsible crab trap of claim 10, wherein a sinker is affixed to the bottom portion of the collapsible crab trap.

19. A collapsible crab trap for catching at least one crab or other marine crustacean, the collapsible crab trap comprising:
(a) at least one upper ring member constructed of flexible materials, the flexible materials comprised of a coiled spring with a protective coating and a sealing means and having an outward spring tension for retaining the ring member in an open configuration;
(b) at least one lower rigid ring member, having a diameter that is smaller than that of the at least one upper ring member and constructed of rigid materials having a lower degree of buoyancy relative to the at least one upper ring member;
(c) a flexible water permeable mesh fastened from a first circumferential surface of the at least one upper flexible ring member to a second circumferential surface of the at least one lower rigid ring member;
(d) a bottom surface attached to the at least one lower rigid ring member; and
(e) at least three flexible lines securely attached to the at least one upper ring member being approximately evenly spaced about the first circumferential surface and joined together with a single line at an opposite end;
whereby, an interior chamber is defined by the flexible water permeable mesh, the at least one upper flexible ring member, the at least one lower rigid ring member, and the bottom surface; and the at least one upper ring member is manually collapsible to a size smaller than its circumference in a collapsed configuration; and
whereby, the single line is pulled flexing the upper ring member inwardly preventing escape of any catch while lifting the collapsible crab trap with the at least one or more crab and other crustacean trapped within the interior chamber.

20. The collapsible crab trap of claim 19, wherein a bait is secured to the bottom surface by at least one bait support for attracting the at least crab or crustacean.
